(19) United States
(12) Patent Application Publication
(10) Pub. No.: US 2014/0352845 A1
(43) Pub. Date: Dec. 4, 2014

(54) VALVE ASSEMBLY FOR USE WITH LIQUID CONTAINER AND DRUG VIAL

(71) Applicant: MEDIMOP Medical Projects Ltd., Ra'anna (IL)

(72) Inventors: Nimrod Lev, Savion (IL); Niv Ben Shalom, Netanya (IL)

(21) Appl. No.: 14/345,094

(22) PCT Filed: Oct. 10, 2012
(86) PCT No.: PCT/IL2012/000354

§ 371 Date: Mar. 14, 2014

(30) Foreign Application Priority Data
Oct. 11, 2011 (IL) 215699

(51) Int. Cl. A61J 1/20

(52) U.S. Cl. CPC A61J 1/20; A61J 2001/201; A61J 2001/2048
USPC 141/329; 141/349; 141/383

(57) ABSTRACT

Valve assemblies for use with a liquid container and a drug vial for enabling an initial transfer of liquid contents from the liquid container to the drug vial for liquid drug formation purposes and subsequent transfer of liquid drug contents from the drug vial to the liquid container for administration purposes. Liquid drug transfer sets can include a valve assembly pre-attached to a liquid container. Alternatively, liquid drug transfer sets can include a valve assembly packaged in sterile blister packaging ready for attachment to a liquid container prior to use.

### FIELD OF THE INVENTION

This invention relates to valve assemblies for use with liquid containers and drug vials.

### BACKGROUND OF THE INVENTION

U.S. Pat. No. 4,607,671 to Aalto et al. illustrates and describes a reconstitution device for constituting a drug in a standard drug vial with a liquid in a second container such as a parenteral solution container. The reconstitution device includes a housing and a hollow, double-pointed needle mounted within the housing. The housing includes a sheath having a substantially circular base and a skirt depending from the base. The skirt includes a free end, a substantially cylindrical inner surface and an outer surface. A plurality of inwardly projecting bumps are intermittently spaced about the inner surface. The bumps are disposed a substantially equal distance from the base, the distance being substantially equal to the width of the malleable band.

U.S. Pat. No. 5,304,163 to Bonnici et al. illustrates and describes an integral reconstitution device including a flexible container having an administration port and a flexible tube extending therefrom. The administration port includes an access membrane through which a spiked cannula can be inserted to gain access to the interior of the flexible container. The flexible tube contains a frangible or breakaway valve therein. Permanently secured to the end of the flexible tube is a sheath having a substantially circular base and an open-ended skirt including an inner surface depending from the base. The skirt includes a plurality of inwardly projecting bumps intermittently spaced around the inner surface to sealingly engage a standard drug vial. A sharp cannula is mounted within the skirt to pierce the stopper of the standard drug vial to establish fluid communication between the cannula and the interior of the drug vial. A peelable closure is provided covering the skirt opening prior to use to maintain a sterile condition of the device. A lumen is provided in housing to establish fluid communication between the cannula and the frangible or breakaway valve.

U.S. Pat. No. 8,025,653 to Capitaine et al. illustrates and describes a luer connector, a medical connector for a receptacle having a piercable stopper and a transfer set including such a luer connector. This luer connector comprises an internal conduit for a fluid to pass, elements of connection to a second luer connector having a perforator, these connection elements being placed at one of its ends. This end also includes a continuous rim forming a projection in the conduit so as to provide a seal thereon when the perforator is introduced into the conduit with a view to coupling these connectors. A breakable membrane is also placed in the conduit so as to be separated when the second luer connector is coupled to this luer connector.

### SUMMARY OF THE INVENTION

The present invention is directed towards valve assemblies for use with a liquid container and a medicament containing drug vial for enabling an initial transfer of liquid contents from the liquid container to the drug vial for liquid drug formation purposes and a subsequent transfer of liquid drug contents from the drug vial to the liquid container for administration purposes. The liquid container can be a bottle, an IV bag, and the like. The liquid container typically includes dual access ports. The liquid contents can either reconstitute a powder medicament or dilute a liquid medicament contained in the drug vial.

The valve assemblies include a conventional drug vial adapter with a cannula and a male connector and an access port adapter having an access port connector for sealing insertion into one of the dual access ports and a female connector for sealingly mounting on the male connector. The drug vial adapter is manually reciprocal with respect to the access port adapter between a closed position for precluding flow communication between a liquid container and a drug vial and an open position for enabling flow communication between a liquid container and a drug vial.

Manual reciprocal arrangements can include inter alia screw thread arrangements, push-pull arrangements, and the like. The reciprocal arrangements enable sealing of the valve assembly after transfer of the liquid contents from a drug vial to a liquid container to avoid draining or leakage from the liquid container to the drug vial. The reciprocal arrangements also preclude breakage of a seal thereby ensuring that no seal fragments or particulates mix with the drug vial contents on transfer of liquid contents.

The male connector is preferably a male Luer lock connector. Suitable drug vial adapters with male Luer lock connectors are commercially available from West Pharmaceutical Services, Inc. Lionville, Pa. 19341, USA www.westpharma.com. The drug vial adapters can be implemented in non-vented and vented versions. The valve assemblies are preferably pre-attached to a liquid container to form a liquid drug transfer set with a removable sealing member mounted on its cannula for ensuring sterile condition until use. Alternatively, liquid drug transfer sets can include a valve assembly packaged in sterile blister packaging ready for attachment to a liquid container prior to use.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of a liquid drug transfer set including a first preferred embodiment of a valve assembly of the present invention pre-attached to an IV bag for use with a drug vial;

FIG. 2 is an exploded view of the valve assembly including a drug vial adapter, an access port adapter and a sealing member;

FIG. 3 is a longitudinal cross section of the valve assembly along line B-B in FIG. 2 showing the drug vial adapter snap fitted on the drug vial;

FIG. 4 is a longitudinal cross section of the access port adapter along line C-C in FIG. 2;

FIG. 5 is a transverse cross section of the access port adapter along line D-D in FIG. 2;

FIG. 6A is a longitudinal cross section of the valve assembly in its closed position along line A-A in FIG. 1;

FIG. 6B is a longitudinal cross section of the valve assembly in its open position along line A-A in FIG. 1;

FIGS. 7A to 7F are pictorial views showing the use of FIG. 1's liquid drug transfer set;

FIG. 8 is a pictorial view of a second preferred embodiment of a valve assembly of the present invention for attachment to an IV bag prior to use;

FIG. 9 is a pictorial view of a third preferred embodiment of a valve assembly of the present invention for attachment to an IV bag prior to use;

FIG. 10 is a longitudinal cross section of FIG. 9's valve assembly along line E-E in FIG. 9;

FIG. 11A is a pictorial view of a fourth preferred embodiment of a valve assembly of the present invention for attachment to a liquid container having dual access ports; and

FIG. 11B is a top plan view of FIG. 11A's liquid container.

### DETAILED DESCRIPTION OF PREFERRED EMBODIMENTS OF THE INVENTION

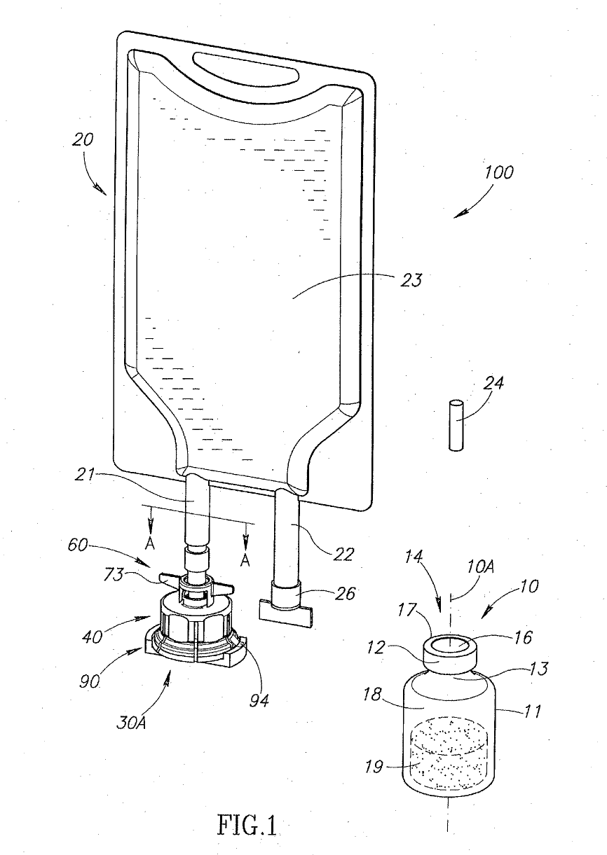

FIG. 1 shows a liquid drug transfer set 100 for use with a drug vial 10. The liquid drug transfer set 100 includes a liquid container 20 constituted by an IV bag and a valve assembly 30A pre-attached to the IV bag 20. The drug vial 10 has a longitudinal drug vial axis 10A and includes a drug vial body 11 with a drug vial rim 12 and a narrow diameter neck 13 intermediate the drug vial body 11 and the drug vial rim 12. The drug vial rim 12 defines a drug vial opening 14 hermetically sealed by a drug vial stopper 16, and capped by a band 17. The drug vial body 11 defines a drug vial interior 18 containing either powder or liquid drug contents 19. The IV bag 20 includes a first access port 21, a second access port 22 and liquid contents 23. The access ports 21 and 22 are in the form of plastic tubing. An access port 21 is typically fitted with a self-sealing plug 24 (shown removed) intended for needle injection of syringe contents into the IV bag 20. The access port 22 is typically sealed by a twist off cap 26 for insertion of an IV spike for administration purposes.

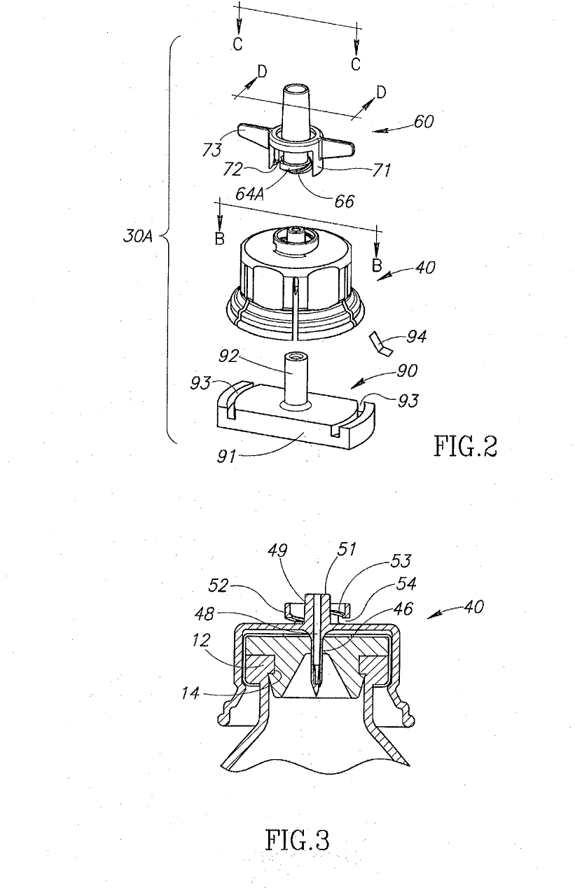

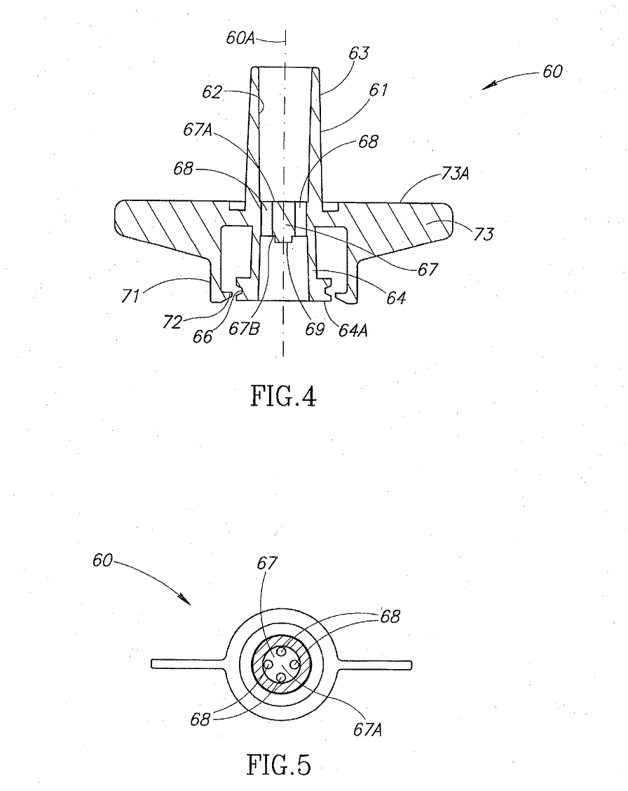

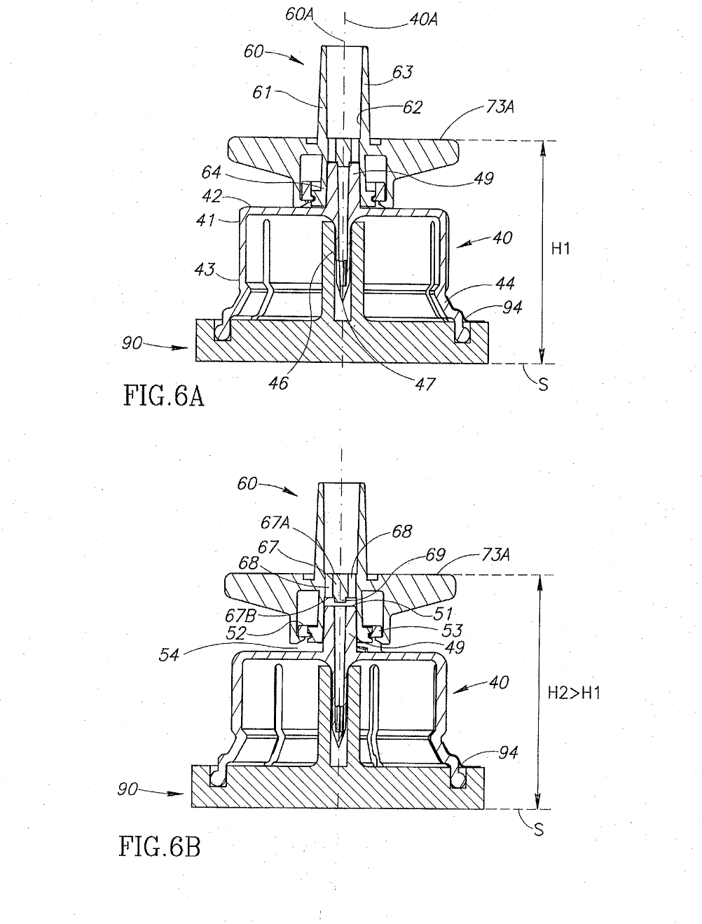

FIGS. 2 to 6 show the valve assembly 30A includes a drug vial adapter 40, an access port adapter 60 pre-attached to the first access port 21, and a sealing member 90. The drug vial adapter 40 is manually rotatable with respect to the access port adapter 60 between a closed position (see FIG. 6A) and an open position (see FIG. 6B). The valve assembly 30A is supplied in the closed position to prevent liquid contents 23 draining from the IV bag 20. The valve assembly 30A is temporarily opened for enabling an initial transfer of liquid contents from the IV bag 20 to the drug vial 10 and subsequent transfer of the liquid drug contents from the drug vial 10 to the IV bag 20 before being re-closed. The empty drug vial 10 preferably remains installed in the drug vial adapter 40 during administration of liquid drug contents via the administration port 22 to a patient but could be optionally detached therefrom.

The drug vial adapter 40 has a longitudinal drug vial adapter axis 40A and includes a drug vial adapter body 41 with a top wall 42 transverse to the longitudinal drug vial adapter axis 40A, a downward depending flared skirt 43 with a multitude of flex members 44 for snap fitting onto the drug vial 10, a pointed tubular cannula 46 with a cannula tip 47 for puncturing the drug vial stopper 16, and a flow communication lumen 48 in flow communication with the cannula 46. The flow communication lumen 48 terminates in an upright male connector 49 mounted on the top wall 42 opposite the cannula 46. The male connector 49 has an annular male connector rim 51. The male connector 49 is formed with a locking collar 52 having an internal screw thread 53 and a pair of opposite peripheral slots 54. The peripheral slots 54 each have a sector angle between about 45° and about 90° to delimit rotation between the drug vial adapter 40 and the access port adapter 60.

The access port adapter 60 has a longitudinal access port adapter axis 60A intended to be co-directional with the longitudinal drug vial adapter axis 40A and preferably co-axial therewith. The access port adapter 60 includes a tubular main body 61 having a lumen 62, an access port connector 63 for sealing insertion into the access port 21 and a female connector 64 for sealingly mounting on the male connector 49. The female connector 64 has a distal end 64A with an external screw thread 66 for screw thread engagement with the internal screw thread 53. The lumen 62 includes a transverse crosspiece 67 midway between the access port connector 63 and the female connector 64. The crosspiece 67 has a crosspiece upperside 67A facing towards the access port connector 63 and a crosspiece underside 67B facing towards the female connector 64. The crosspiece 67 includes four equispaced longitudinal throughgoing bores 68 peripherally disposed adjacent the main body 61. The crosspiece underside 67B is formed with a sealing projection 69 for selective sealing insertion into the flow communication lumen 48 at the male connector 49.

The access port adapter 60 includes a pair of longitudinal directed legs 71 each having an inwardly directed projection 72 facing towards the external screw thread 66 for insertion into the peripheral slots 54. The access port adapter 60 includes a pair of opposite radial directed wings 73 for assisting manual rotation of the drug vial adapter 40 relative to the access port adapter 60. The wings 73 have uppermost wing surfaces 73A. The female connector 64's pair of longitudinal directed legs 71 with their corresponding inwardly directed projections 72 are rotatable in the locking collar 52's pair of peripheral slots 54 between a first extreme position corresponding with a closed position of the valve assembly 30A (see FIG. 6A) and a second opposite extreme position corresponding with an open position of the valve assembly 30A (see FIG. 6B).

In the closed position, the annular male connector rim 51 bears against the crosspiece underside 67B to seal the peripheral throughgoing bores 68 for sealing the lumen 62 for precluding flow communication between the IV bag 20 and the drug vial 10. The sealing projection 69 is sealingly inserted in the flow communication lumen 48 at the male connector 49 in the closed position to ensure no liquid leakage through the lumen 62. The uppermost wing surfaces 73A define a height H1 relative to a reference surface S in the closed position. Manual loosening rotation of the drug vial adapter 40 relative to the access port adapter 60 delimited by the movement of the inwardly directed projections 72 within the peripheral slots 54 displaces the annular male connector rim 51 from the crosspiece underside 67B to unseal the peripheral throughgoing bores 68 for unsealing the lumen 62 in the open position for enabling flow communication between the access port connector 63 and the female connector 64 (see FIG. 6B). The uppermost wing surfaces 73A define a height H2 relative to the reference surface S in the open position where H2>H1. The height difference H2−H1 is typically in the region of about 1 mm and depends on the pitch of the screw thread of the drug vial adapter 40 and the access port adapter 60 and the sector angle of peripheral slots 54.

The sealing member 90 includes a securing member 91 extending across the skirt 43 and a sleeve 92 mounted upright on the securing member 91 for sealingly mounting on the cannula 46. The securing member 91 includes slits 93 for fitting onto opposite flex member distal ends. The sealing member 90 includes a tamper proof evidence foil 94 for indicating integrity of the valve assembly 30A prior to use.

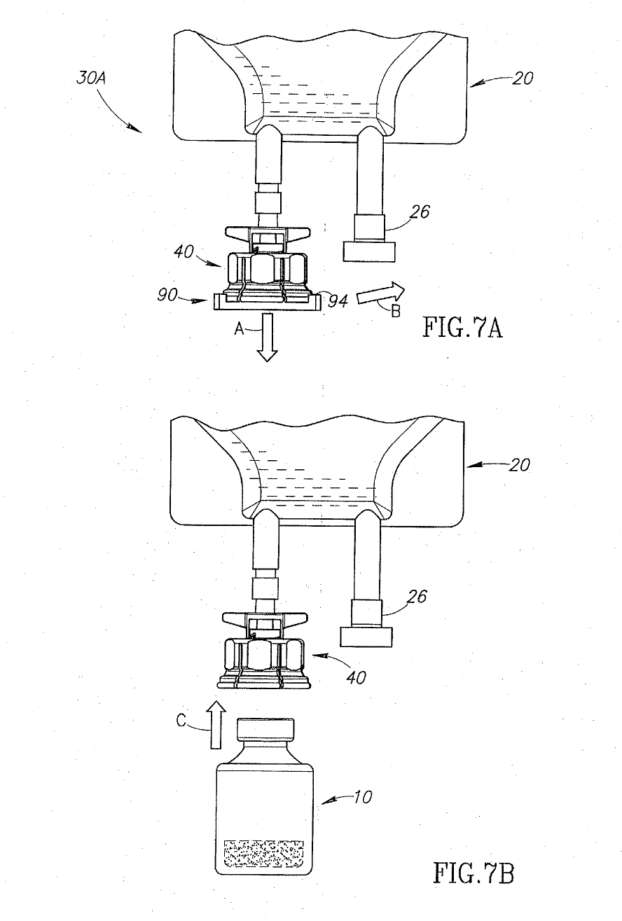

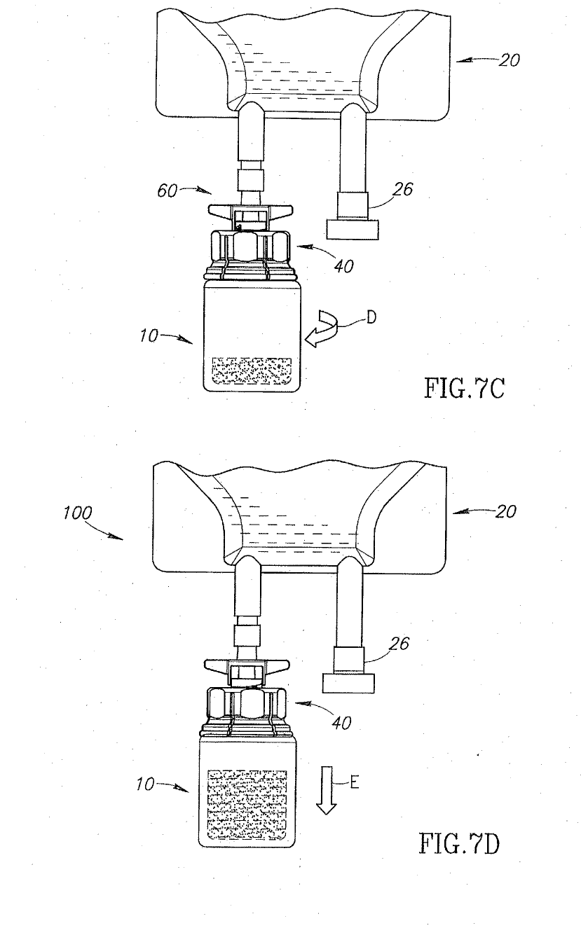

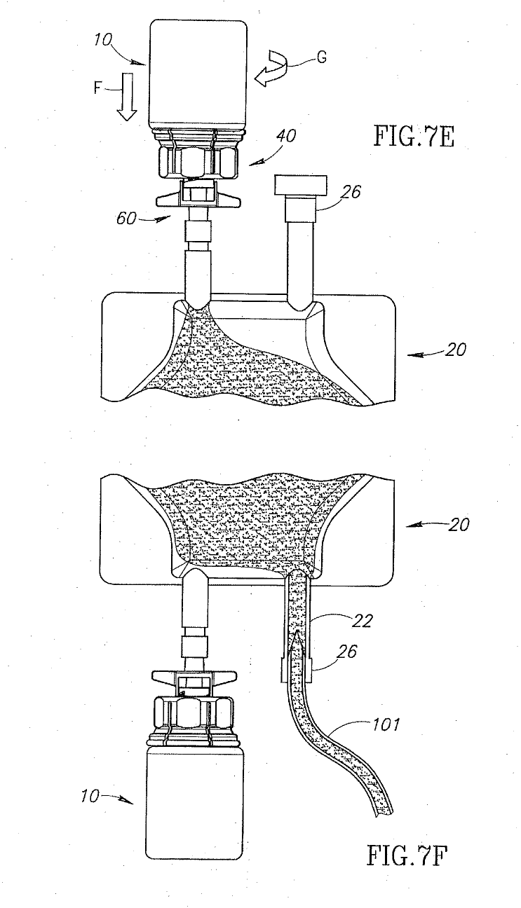

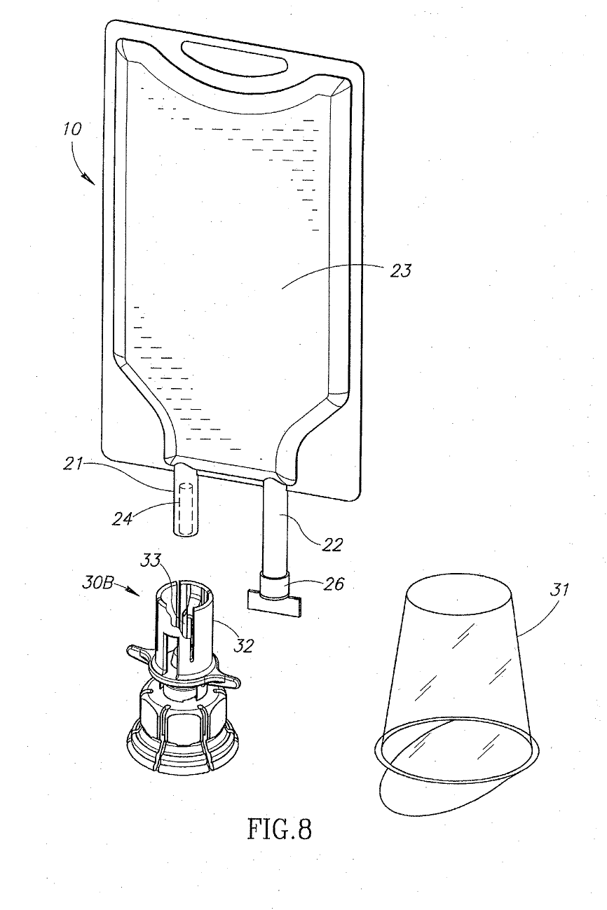

FIGS. 7A to 7F show use of the liquid drug transfer set 100 as follows:

FIG. 7A shows the valve assembly 30A in its closed position and fitted with its sealing member 90 mounted on the drug vial adapter 40. FIG. 7A also shows removal of the sealing member 90 as denoted by arrow A to expose the cannula 46 prior to snap fit insertion of the drug vial 10 into the drug vial adapter 40 as denoted by arrow C (see FIG. 7B). Removal of the sealing member 90 detaches the evidence foil 94 from the drug vial adapter 40 as denoted by arrow B.

FIG. 7C shows manual loosening rotation of the drug vial adapter 40 together with its installed drug vial 10 relative to the access port adapter 60 as denoted by arrow D for urging the valve assembly 30A from its closed position to its open position for enabling flow communication from the IV bag 20 to the drug vial 10 for transfer of liquid contents from the former to the latter.

FIG. 7D shows squeezing the IV bag 20 to transfer liquid contents into the drug vial 10 as denoted by arrow E prior to agitation of the liquid drug transfer set 100 for forming the liquid drug in the drug vial 10.

FIG. 7E shows inversion of the liquid drug transfer set 100 for transfer the liquid drug contents from the drug vial 10 to the IV bag 20 as denoted by arrow F prior to manual tightening rotation of the drug vial adapter 40 and its installed drug vial relative to the access port adapter 60 for closing the valve assembly 30A as denoted by arrow G.

FIG. 7F shows inversion of the liquid drug transfer set 100 and insertion of an infusion set into the second access port 22 after opening the twist off cap 26 for administering the liquid drug contents to a patient.

FIGS. 8 to 11 show three valve assemblies 30B, 30C and 30D similar in construction and operation as the valve assembly 30A and therefore similar parts are likewise numbered.

The valve assemblies 30B and 30C are shown in use with an IV bag 20 having a first access port 21 fitted with a self-sealing plug 24 and a second access port 22 fitted a twist off cap 26. The valve assemblies 30B, 30C and 30D are intended to be supplied as a discrete item in a sterile blister pack 31 therefore precluding the need for the sealing member 90.

FIG. 8 shows a valve assembly 30B includes a shroud 32 for snugly sliding onto the access port 21 and a needle 33 for penetration through the self-sealing plug 24. The shroud 32 is shown partially broken away to show the needle 33.

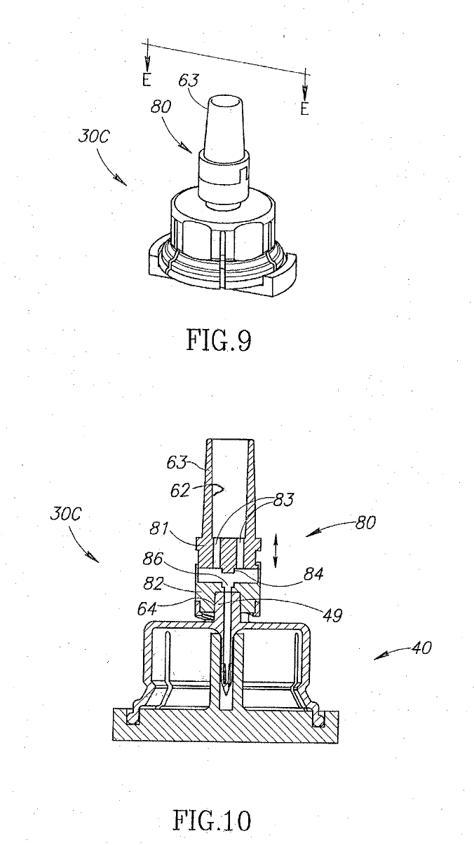

FIGS. 9 and 10 show a valve assembly 30C including a push-pull type reciprocation arrangement for enabling manual linear reciprocation of the drug vial adapter 40 with respect to the access port adapter 60 for disposing the valve assembly 30C between a closed position and an open position. The valve assembly 30C includes a dual component access port adapter 80 having a leading access port adapter component 81 with the access port connector 63 for sealing insertion into an access port and a trailing access port adapter component 82 having the female connector 64 for sealing mounting on the male connector 49. The trailing access port adapter component 82 is integrally formed with the drug vial adapter 40. Suitable bonding means for integrally mounting the trailing access port adapter component 82 on the drug vial adapter 40 includes inter alia gluing, ultrasound, and the like.

The leading access port adapter component 81 includes a pair of longitudinal lumens 83 lateral to a sealing projection 84. The trailing access port adapter component 82 includes a longitudinal lumen 86 in flow communication with the lumen 62. In the closed position of the valve assembly 30C, the sealing projection 84 seals the lumen 86 for precluding flow communication between an IV bag and a drug vial. In the open position of the valve assembly 30C, the sealing projection 84 is disposed above the lumen 86 for enabling flow communication between the lumens 83 and the lumen 86 and therefore between an IV bag and drug vial.

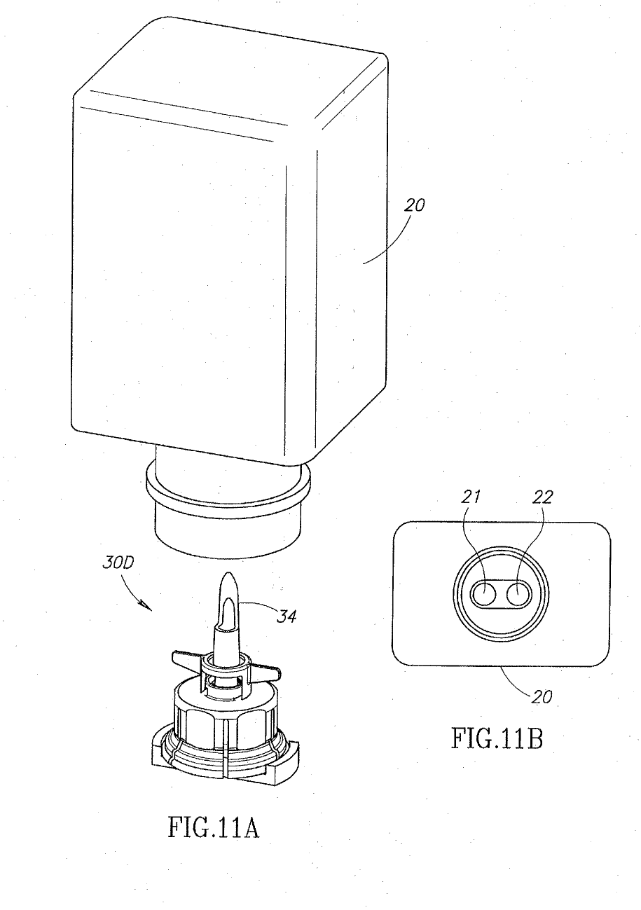

FIGS. 11A and 11B show a valve assembly 30D in use with a liquid container 20 constituted by a bottle and having dual access ports 21 and 22. The valve assembly 30D is similar to the valve assembly 30A but includes an access port spike 34 for sealing sliding insertion into one of the ports 21 and 22.

While the invention has been described with respect to a limited number of embodiments, it will be appreciated that many variations, modifications, and other applications of the invention can be made within the scope of the appended claims.

1.-9. (canceled)

10. A valve assembly for use with a liquid container and a drug vial, the liquid container including dual access ports and containing liquid contents, and the drug vial having a drug vial stopper and a drug vial interior containing a medicament, the valve assembly comprising:
(a) a drug vial adapter having a longitudinal drug vial adapter axis and including a drug vial adapter body with a top wall transverse to said longitudinal drug vial adapter axis, a pointed tubular cannula with a cannula tip for puncturing the drug vial stopper for establishing flow communication with the drug vial interior on mounting said drug vial adapter on the drug vial, and 10 an upright male connector mounted on said top wall opposite said cannula and in flow communication therewith, said male connector having an uppermost annular male connector rim; and
(b) an access port adapter having a longitudinal access port adapter axis co-directional with said longitudinal drug vial adapter axis and including an access 15 port connector for sealing insertion into one of the access ports and a female connector for sealingly mounting on said male connector,
said drug vial adapter being manually-reciprocally mounted on said access port adapter so as to be manually reciprocal with respect thereto along said longitudinal drug vial adapter axis between a closed position for 20 precluding flow communication between the liquid container and the drug vial and an open position for enabling flow communication between the liquid container and the drug vial,
said drug vial adapter being disposed toward said access port adapter on displacement from said open position to said closed position and away from 25 said access port adapter on displacement from said closed position to said open position.

11. The assembly according to claim 10, wherein said drug vial adapter includes a locking collar peripheral to said male connector, said locking collar 30 having at least two peripheral slots,
said access port adapter includes a corresponding number of longitudinal directed legs each having an inwardly directed projection for insertion into said at least two peripheral slots such that said drug vial adapter is manually rotationally reciprocal relative to said access port adapter between said closed position and said open position,
said access port adapter further includes a lumen for flow communication between said access port connector and said female connector, said lumen having a transverse crosspiece with at least one peripheral throughgoing bore for enabling said flow communication between said access port connector and said female connector,
said drug vial adapter urging said annular male connector rim against said crosspiece to seal said at least one peripheral throughgoing bore for sealing said lumen in said closed position and displacing said annular male connector rim from said crosspiece to unseal said at least one peripheral throughgoing bore in said open position.

12. The assembly according to claim 11, wherein said access port adapter includes a sealing projection for sealing insertion into said flow communication lumen at said male connector in said closed position.

13. The assembly according to claim 11, wherein said access port adapter includes at least one radial directed wing for assisting said manual rotation of said drug vial adapter relative to said access port adapter.

14. The assembly according to claim 10, wherein said access port adapter has a dual component construction including a leading access port adapter component having said access port connector and a trailing access port adapter component having said female connector for sealing mounting on said male connector, said trailing access port adapter component being integrally formed with said drug vial adapter,
said drug vial adapter being manual linearly reciprocal to said leading access port adapter component along said longitudinal drug vial adapter axis between said closed position for precluding flow communication between said male connector and said access port connector and said open position for enabling flow communication between the liquid container and the drug vial.

15. The assembly according to claim 10, for pre-attachment to the liquid container and further comprising a sealing member for removable mounting on said cannula.

16. The assembly according to claim 15, wherein the drug vial adapter body includes a downward depending flared skirt with a multitude of flex members for snap fitting onto the drug vial and said sealing member includes a securing member extending across said skirt and a sleeve mounted upright on said securing member for sealing mounting on said cannula.

17. The assembly according to claim 15, wherein said sealing member includes a tamper proof evidence foil extending between said sealing member and said drug vial adapter for indicating removal of said sealing member from said drug vial adapter.

18. A liquid drug transfer set comprising a liquid container with a pre-attached valve assembly according to claim 10.
